(19) United States
(12) Patent Application Publication
(10) Pub. No.: US 2026/0100035 A1
(43) Pub. Date: Apr. 9, 2026

(54) Detecting a Dwelling in Satellite Image Data for Resource Provisioning in Rural Settlements

(71) Applicants: Roshan Taneja, Cupertino, CA (US); Yuvraj Taneja, Cupertino, CA (US)

(72) Inventors: Roshan Taneja, Cupertino, CA (US); Yuvraj Taneja, Cupertino, CA (US)

(21) Appl. No.: 19/346,990

(22) Filed: Oct. 1, 2025

Related U.S. Application Data
(60) Provisional application No. 63/703,232, filed on Oct. 4, 2024.

(51) Int. Cl. G06V 20/10; G06V 10/762; G06V 10/82; G06V 20/13

(52) U.S. Cl. CPC G06V 20/176; G06V 10/762; G06V 10/82; G06V 20/13; G06V 2201/10

(57) ABSTRACT

A method and system for detecting a dwelling in satellite image data for resource provisioning in rural settlements are provided. The method includes accessing satellite image data and obtaining satellite images of rural areas and training a model to detect dwellings present in the satellite images. The method includes inputting a series of satellite images into the model to detect dwelling locations. The method includes storing a dwelling location if a dwelling is detected in a satellite image, and storing the dwelling location in a dwelling database. The method includes provisioning a resource to a dwelling location. The resource may be a water harvesting unit. The method includes outputting the dwelling location for provisioning the resource to the dwelling.

### CROSS-REFERENCE(S) TO RELATED APPLICATIONS

This application claims priority from United States provisional patent application number 63/703,232 filed on 4 Oct. 2024, which is incorporated by reference herein.

### FIELD

This disclosure relates to detecting a dwelling in satellite image data for resource provisioning in rural settlements. Particularly, the disclosure relates to detecting dwellings using a computer vision model for resource provisioning.

### BACKGROUND

In the remote regions of Northern Tanzania, women and children of the Maasai Tribe can walk up to nine hours a day to collect water. Persistent droughts and floods can result in water insecurity for the communities. During times of drought, members of the community may need to walk long distances from their boma, a localized structure or structures for housing a community of people, to obtain water. During times of flooding, their boma's could become flooded and they may need to move to other areas even if they are not nomadic.

The difficulties related to water insecurity may be partially alleviated with the installation of water harvesting units close to the boma. This may limit the distance that people need to travel to access water. Reducing the time needed to obtain water may have further improvements on the lives of the community. Children could attend school instead of spending hours per day walking to retrieve water, and could use the extra time for social, agricultural and economic activities.

Due to the potentially dispersed nature of the bomas, a single water harvesting unit or facility may not be able to service all communities spread across the bomas. Therefore, a distributed approach to providing water harvesting units directly where they are needed may be required. However, it is first necessary to know where the bomas and communities are.

Within the remote regions of Northern Tanzania, the exact number and locations of bomas might not be known. It is therefore necessary to determine the exact location of bomas and potentially the individual housing units within them. Additionally, due to the vast area of land the bomas can cover, a cheap, efficient and effective means of determining where the bomas are located is required.

### THERE ACCORDINGLY REMAINS SCOPE FOR IMPROVEMENT.

The preceding discussion of the background is intended only to facilitate an understanding of the present disclosure. It should be appreciated that the discussion is not an acknowledgment or admission that any of the material referred to was part of the common general knowledge in the art as at the priority date of the application.

### SUMMARY

In accordance with an aspect of the disclosure there is provided a computer-implemented method for detecting a dwelling in satellite image data for resource provisioning in rural settlements, the method comprising: accessing the satellite image data and obtaining a satellite image from the satellite image data; inputting the satellite image into a trained model, wherein the trained model outputs a classification indicating whether a dwelling is present in the satellite image; storing in a dwelling database, when the trained model outputs a classification indicating that a dwelling is present in the satellite image, a dwelling location based on a location associated with the satellite image; performing a clustering using a plurality of dwelling locations, obtained by retrieving dwelling locations stored in the dwelling database, to determine a clustering of dwellings; and, outputting the dwelling location for provisioning of a resource to the dwelling, including outputting a cluster location associated with the clustering of dwellings.

The method may include: accessing the satellite image data including a set of satellite images and satellite image meta data; processing the set of satellite images to form a training dataset and a validation dataset of satellite images; generating a model to determine whether a dwelling is present in the satellite image; training the model using the training dataset to obtain a trained model; validating the trained model using the validation dataset; outputting the trained model; and, storing the trained model in a model database.

Processing the set of satellite images to form a training dataset may include compiling the training dataset including satellite images of dwellings. Compiling the training dataset may include replicating each satellite image of a dwelling a predetermined number of times and rotating each replica satellite image to an orientation which is different from an original satellite image of the dwelling and each other replica satellite image. The predetermined number of times is three and each of the three replicas is rotated each of: 90 degrees; 180 degrees and 270 degrees relative to the original satellite image of the dwelling.

The method may include obtaining a series of satellite images from the satellite image data and inputting each satellite image from the series of satellite images into the trained model and storing, for each satellite image from the series of satellite images in which the classification indicates that a dwelling is present, a dwelling location based on a location associated with that satellite image.

The series of satellite images may be determined based on a geographical area of interest. The method includes receiving input of the geographical area of interest and using the geographical area of interest to obtain the series of satellite images from the satellite image data.

The location of a satellite image may be a geographical coordinate of a center of the satellite image. The satellite image meta data may include, for each image, any one or more from the group of: a time stamp of when the image was captured by a satellite, a geographical coordinate corresponding to a geographical area captured within the satellite image, a resolution of the satellite image, a pixel density of the satellite image, an orientation, and a camera model.

The resource may be any one of the group of: a water supply unit; a healthcare unit, or a drone delivery dispatch. Outputting the dwelling location for provisioning of the resource may include transmitting an instruction to deploy the resource at or to or proximate the dwelling location.

The dwelling database may indicate, for each dwelling location, the presence or absence of the resource. Outputting the dwelling location for provisioning of the resource includes outputting the dwelling location when the absence of the resource is indicated.

Storing the location of the satellite image as a dwelling location in a dwelling database may include storing a corresponding time stamp of when the satellite image was captured by a satellite.

The model may be a neural network. The neural network may be a convolutional neural network comprising three input channels and two output channels. Each output channel may be a value ranging between 0 or 1, one output indicating the probability of a dwelling being present in the satellite image and the other output indicating no dwelling is present in the satellite image.

The model may be an image classifier that determines the probability that a dwelling is present in the satellite image.

The method may include compiling the plurality of dwelling locations, as an input to a clustering algorithm to determine the clustering of dwellings. Each clustering of dwellings may comprise a list of dwelling locations within said cluster. The clustering algorithm may be a K-means clustering algorithm. A combination of all dwelling locations across all clusters may form a subset of all dwelling locations in the dwelling database.

Outputting the dwelling location for provisioning of a resource to the dwelling may include outputting the clustering of dwellings.

The method may include determining, in association with the dwelling location, a water consumption estimation and a type of water harvesting unit sized according to the water consumption estimation and outputting an indication of the type suitable water harvesting unit in association with the dwelling location.

The method may further include: obtaining an updated set of satellite images, wherein the updated set of satellite images includes satellite images which are captured by a satellite at a later time than the images in the set of satellite images; inputting at least one updated satellite image selected from the updated set of satellite images into the trained model; and, storing, if the trained model output classification indicates that a dwelling exists in the updated satellite image, a location of the updated satellite image as an updated dwelling location in a dwelling database with a corresponding time stamp of when the updated satellite image was captured by a satellite.

The method may include performing a temporal analysis of a variation of the dwelling locations using the updated dwelling locations to output a new set of dwelling locations and an updated clustering of dwellings.

Obtaining a set of satellite images may include obtaining the images from a satellite image database, repeatedly selecting images at a plurality of geographical locations of a predefined size and where a combination of all satellite images forms a complete covering of a predefined geographical area

At least a portion of satellite images within the set of satellite images may partially overlap with each other.

Processing of the set of satellite images may include augmenting the satellite images by performing any one of the group of: rotating, cropping, varying a resolution, varying a scale, varying a color scale, varying a pixel size, or varying a contrast.

The satellite image may be: 100 pixels by 100 pixels, each pixel representing one square meter. The satellite image may be a raw RGB color. The satellite image may be a three channel image.

The model may be generated and trained in a first environment.

The trained model may be deployable to and executable within a satellite image data environment.

In accordance with a further aspect of the disclosure there is provided a system for detecting a dwelling in satellite image data for resource provisioning in rural settlements, the system comprising: a non-transitory computer-readable storage medium; and one or more processors coupled to the non-transitory computer-readable storage medium, wherein the non-transitory computer-readable storage medium comprises program instructions that, when executed on the one or more processors, cause the system to perform operations comprising: accessing the satellite image data and obtaining a satellite image from the satellite image data; inputting the satellite image into a trained model, wherein the trained model outputs a classification indicating whether a dwelling is present in the satellite image; storing in a dwelling database, when the trained model outputs a classification indicating that a dwelling is present in the satellite image, a dwelling location based on a location associated with the satellite image; performing a clustering using a plurality of dwelling locations, obtained by retrieving dwelling locations stored in the dwelling database, to determine a clustering of dwellings; and, outputting the dwelling location for provisioning of a resource to the dwelling, including outputting a cluster location associated with the clustering of dwellings.

In accordance with a further aspect of the disclosure there is provided a system detecting a dwelling in satellite image data for resource provisioning in rural settlements, the system including: a memory for storing computer-readable program code and a processor for executing the computer-readable program code, the system comprising: a satellite data accessing component for accessing the satellite image data and an image obtaining component for obtaining a satellite image from the satellite image data; an image input component for inputting the satellite image into a trained model, wherein the trained model outputs a classification of if a dwelling is present in the satellite image; a location storing component for storing, if the trained model output classification indicates that a dwelling exists in the satellite image, a location of the satellite image as a dwelling location in a dwelling database; a clustering component for performing a clustering using a plurality of dwelling locations, obtained by retrieving dwelling locations stored in the dwelling database, to determine a clustering of dwellings; and, a location outputting component for outputting the dwelling location for provisioning of a resource to the dwelling, including outputting a cluster location associated with the clustering of dwellings.

The system may further include: a memory for storing computer-readable program code and a processor for executing the computer-readable program code, the system comprising: an image accessing component for accessing the satellite image data which include: a set of satellite images and satellite image meta data; an image obtaining component for obtaining a set of satellite images from the satellite image data; an image processing component for processing the set of satellite images to form a training dataset and a validation dataset of satellite images; a model generating component for generating a model for use in determining if a dwelling exists in a satellite image; a model training component for training the model using the training dataset to obtain a trained model; and, a model validation component for validating the trained model using the validation dataset; a model outputting component for outputting the trained model; and, a model storing component for storing the trained model in a model database

In accordance with a further aspect of the disclosure there is provided a computer program product for detecting a dwelling in satellite image data for resource provisioning in rural settlements, the computer program product comprising a computer-readable medium having stored computer-readable program code for performing the steps of: accessing the satellite image data and obtaining a satellite image from the satellite image data; inputting the satellite image into a trained model, wherein the trained model outputs a classification indicating whether a dwelling is present in the satellite image; storing in a dwelling database, when the trained model outputs a classification indicating that a dwelling is present in the satellite image, a dwelling location based on a location associated with the satellite image; performing a clustering using a plurality of dwelling locations, obtained by retrieving dwelling locations stored in the dwelling database, to determine a clustering of dwellings; and, outputting the dwelling location for provisioning of a resource to the dwelling, including outputting a cluster location associated with the clustering of dwellings.

Further features provide for the computer-readable medium to be a non-transitory computer-readable medium and for the computer-readable program code to be executable by a processing circuit.

Embodiments of the technology will now be described, by way of example only, with reference to the accompanying drawings.

### BRIEF DESCRIPTION OF THE DRAWINGS

### In the Drawings:

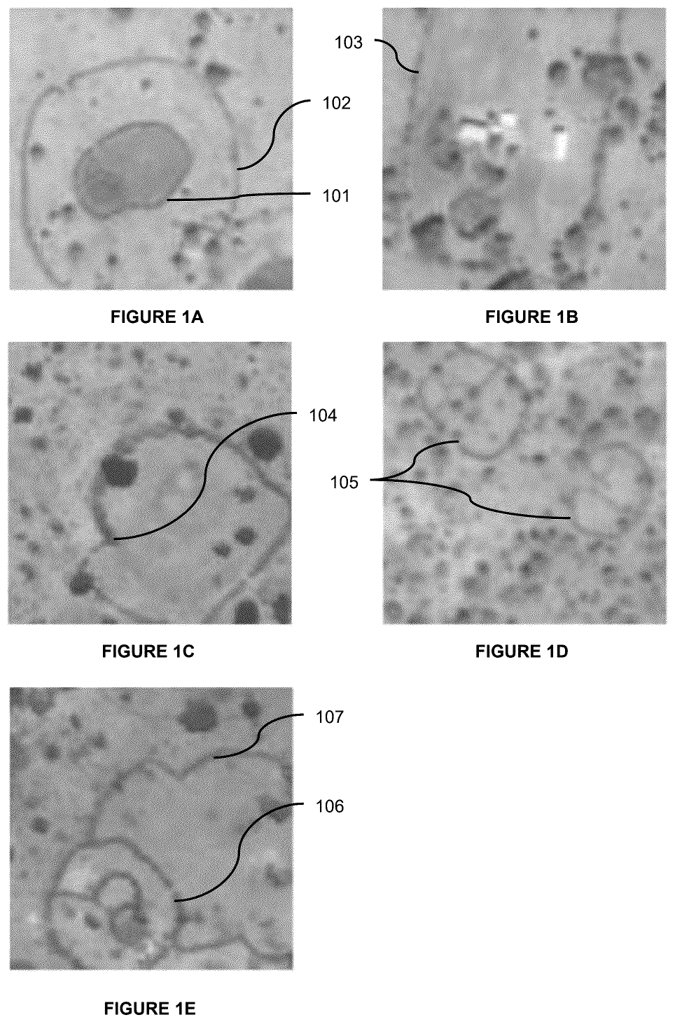

FIG. 1A is an exemplary satellite image of a dwelling within another larger dwelling;

FIG. 1B is an exemplary satellite image of an elongated, elliptical shaped dwelling;

FIG. 1C is an exemplary satellite image of a dwelling with a sharp corner in the dwelling wall;

FIG. 1D is an exemplary satellite image of two dwellings within one satellite image;

FIG. 1E is an exemplary satellite image of a dwelling attached to the side of another dwelling;

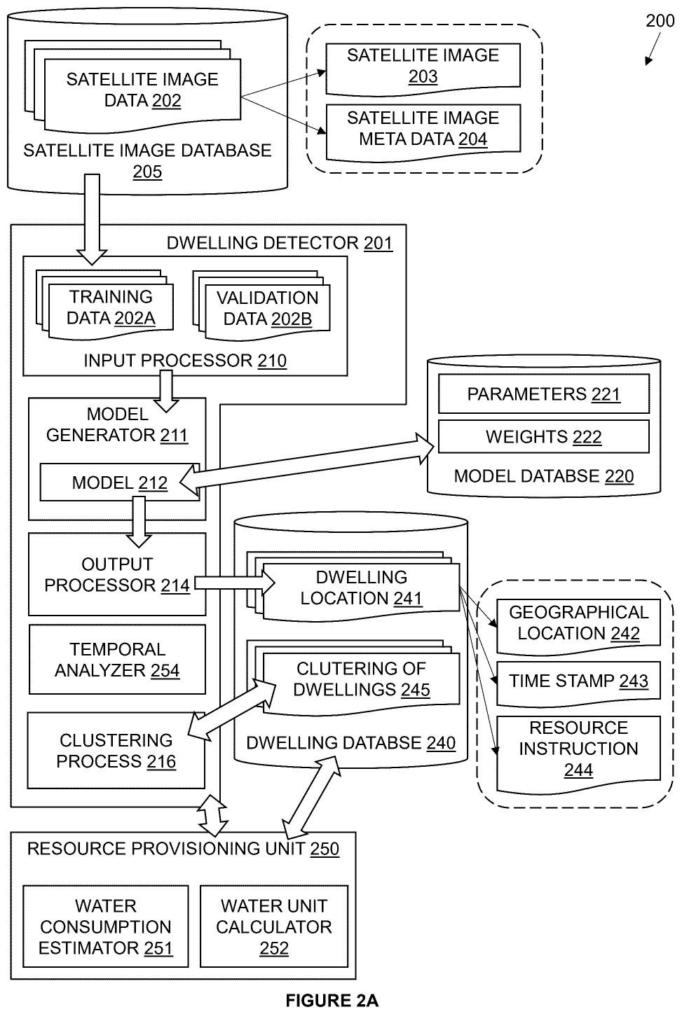

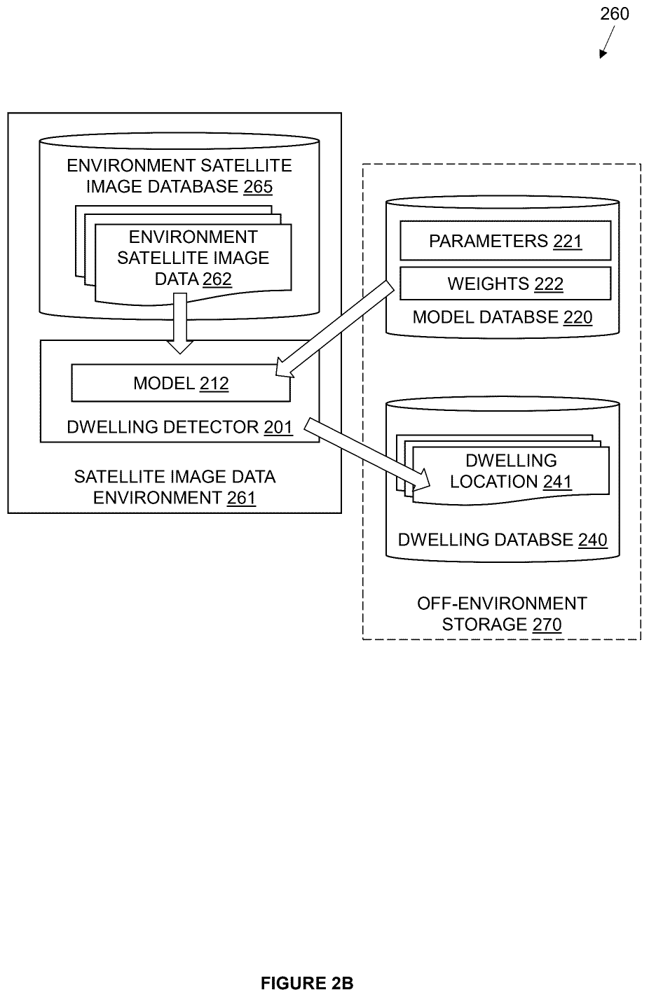

FIG. 2A is a schematic diagram which illustrates an example system for detecting a dwelling in satellite image data for resource provisioning in rural settlements according to aspects of the present disclosure;

FIG. 2B is a schematic diagram which illustrates an example system deployed within a satellite image data environment for detecting dwellings according to aspects of the present disclosure;

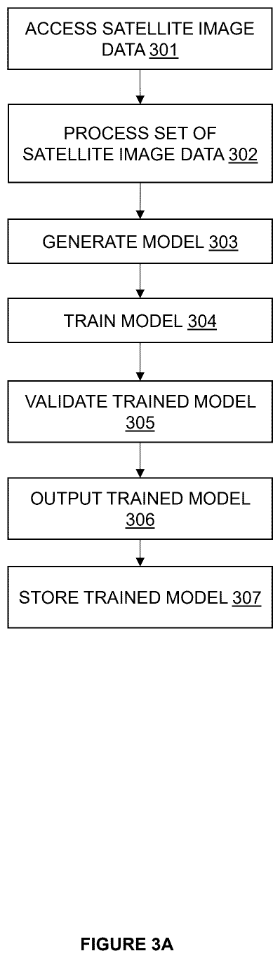

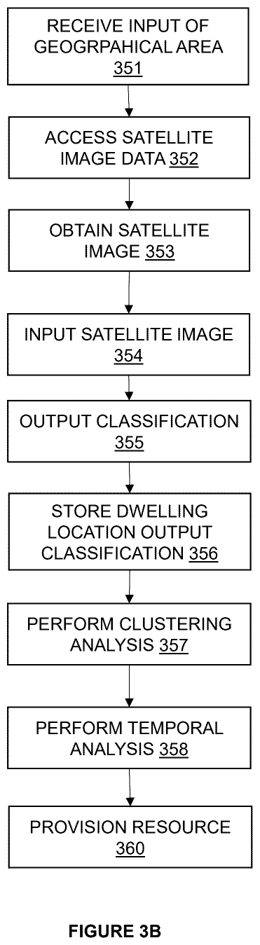

FIG. 3A is a flow diagram which illustrates an example method for training a model for detecting dwellings in satellite images using a model according to aspects of the present disclosure;

FIG. 3B is a flow diagram which illustrates an example method for detecting a dwelling in satellite image data for resource provisioning in rural settlements according to aspects of the present disclosure;

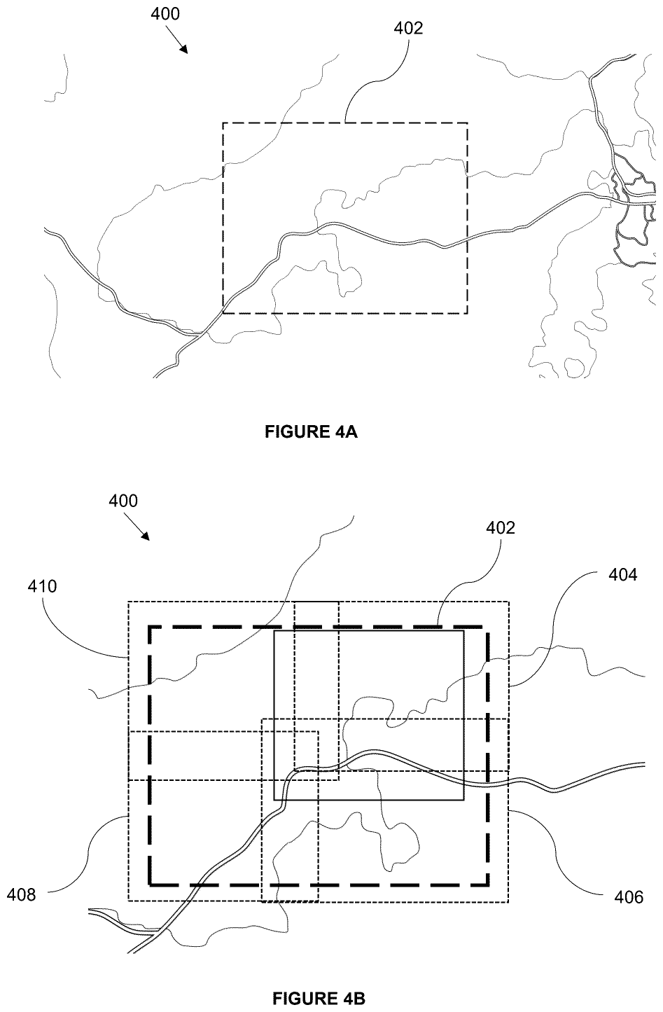

FIG. 4A is an illustration of an exemplary topographical map and a predefined geographical area;

FIG. 4B is an illustration of an exemplary topographical map and a predefined geographical area, and multiple satellite images covering the predefined geographical area;

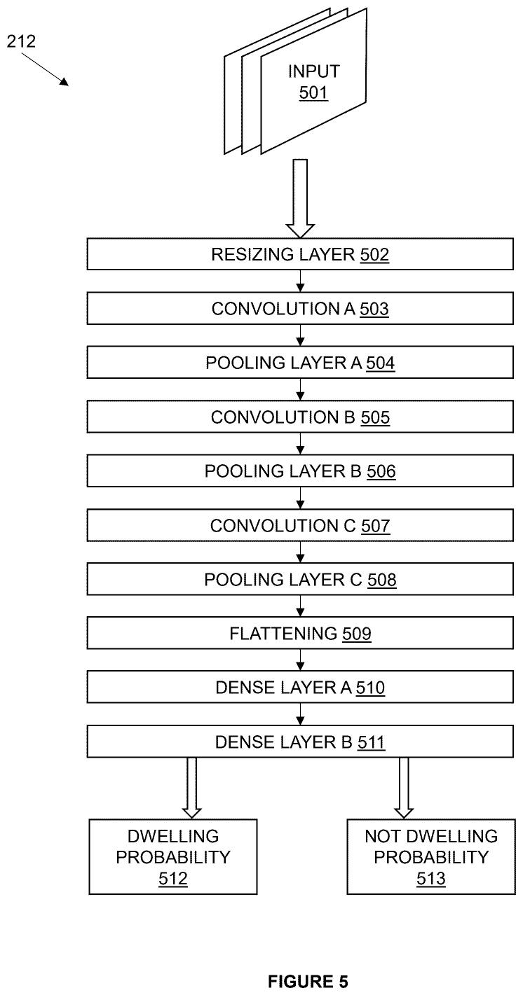

FIG. 5 is a schematic diagram of an exemplary convolutional neural network architecture;

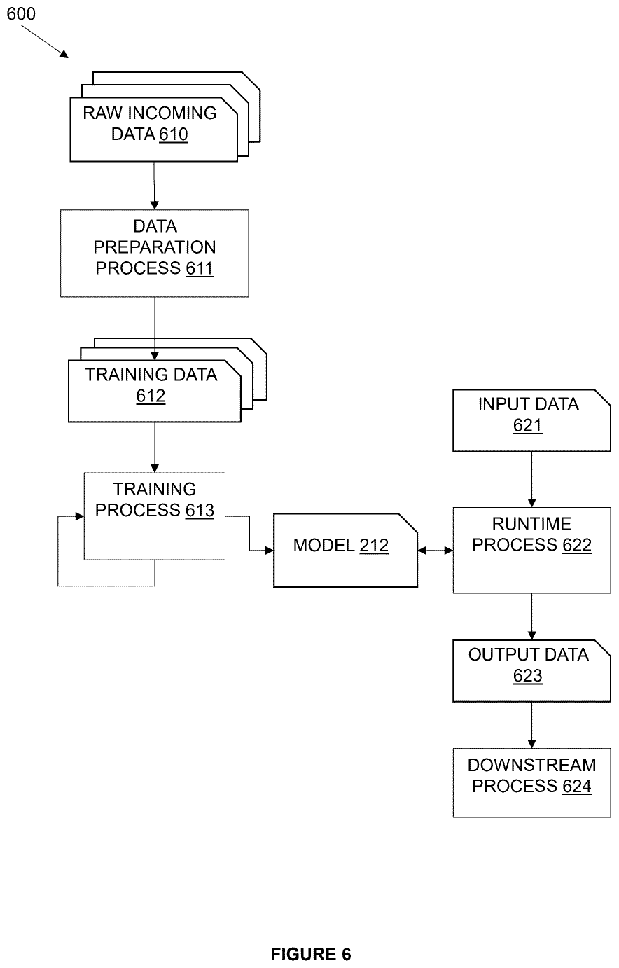

FIG. 6 is a flow diagram of an example embodiment of a training procedure for training the model;

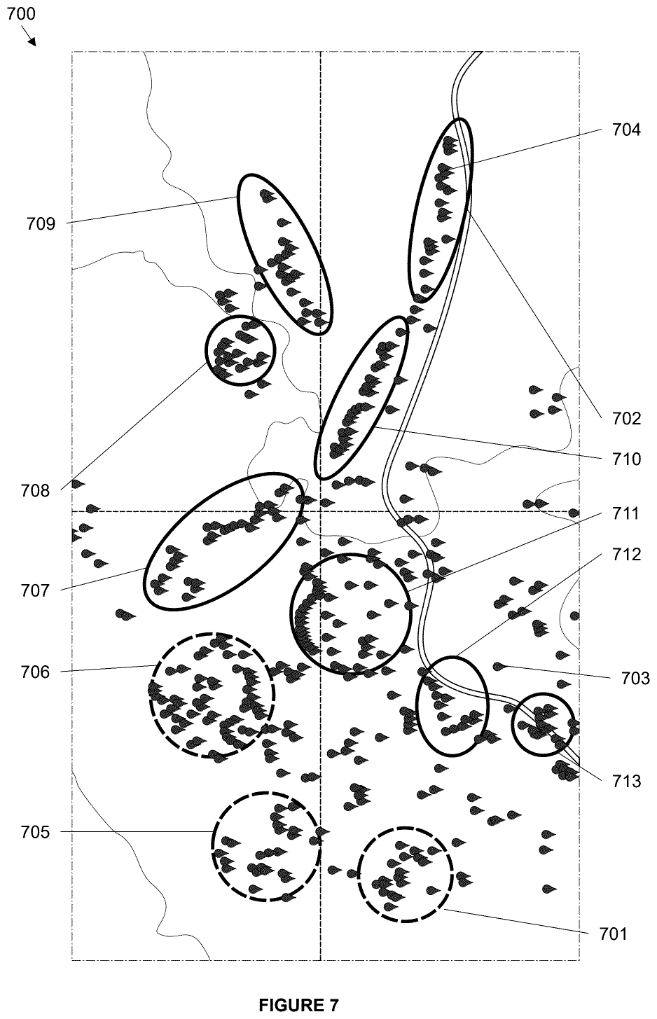

FIG. 7 is an illustration of an exemplary topographical map with a plurality of dwelling locations clustered into multiple clusters;

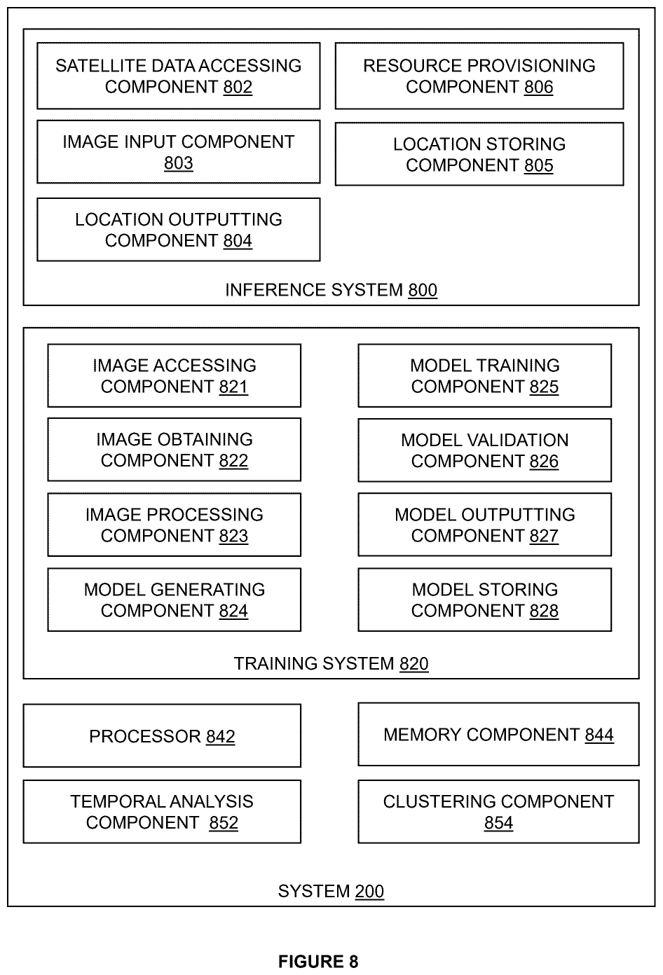

FIG. 8 is a block diagram which illustrates a system for detecting a dwelling in satellite image data for resource provisioning in rural settlements according to aspects of the present disclosure; and,

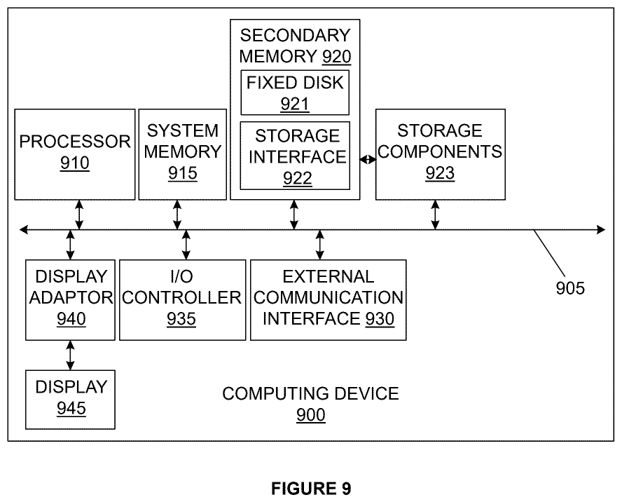

FIG. 9 illustrates an example of a computing device in which various aspects of the disclosure may be implemented.

### DETAILED DESCRIPTION WITH REFERENCE TO THE DRAWINGS

A method and system for detecting a dwelling in satellite image data for resource provisioning in rural settlements are provided. Within various rural areas, communities may live in dwellings in the form of bomas. Due to their dispersed nature and distance from centralized services, these communities may need to travel long distances to access vital resources. Such resources may be water or healthcare services. The system and method described herein may find particular, although not exclusive, application in the detection of dwellings in the form of bomas of the Maasai people of Northern Tanzania.

A variety of resources may be required to be provisioned to these communities. Various types of resources may be provisioned. For example, provisioning of water harvesting units may be used to help alleviate the water insecurity faced by these communities. Such water harvesting units may be water storage facilities, which may range from smaller units holding approximately 5,000 liters of water, to larger units holding up to 100,000 liters of water. Other water harvesting units may include a man-made pond for collecting rainwater, combined with a solar-powered pump and filtration unit. Providing water harvesting units closer to the dwellings may improve socio-economic conditions of people living in these remote areas. In some examples, provisioning healthcare services may help to alleviate illness and disease by providing health care units (facilities). However, when provisioning a resource, it is required to know where the dwellings of such communities are located and how many dwellings there may be in order to size and provision a unit.

Utilizing satellite images for this purpose is convenient as the images may be at a suitable quality and cover the rural areas. In addition to determining where the dwellings are, it may be required to estimate a density of dwellings. The density of dwellings may indicate the number of dwellings per unit area, such as per square kilometer or square mile. Various factors, including the dwelling locations and density, may be required to pick the best location for the units that balance cost, unit type, unit size, ease of deployment of the unit, and sustainability.

In one example implementation, the dwellings of interest may include a fence-like structure, which may resemble a circular-type shape when viewed from above. A collection of satellite images of example dwellings are shown in FIGS. 1A to 1E. The collection of satellite images shows that the dwellings may present varying shapes and orientations. FIG. 1A shows a dwelling with an inner wall 101 within an outer wall 102. This may add difficulties to detecting the dwelling, as it may be a single dwelling with an inner wall. A system for dwelling detection may, for example, only detect the inner wall as a dwelling or may possibly classify it as two dwellings. In some examples, the inner wall may be a structure to house livestock, and the outer wall is a boundary of the dwelling. FIG. 1B shows an elongated and elliptical dwelling 103 shape. This shape varies from a more typical circular shaped dwelling. FIG. 1C shows a dwelling with a sharp corner 104 in the wall of the dwelling, forming a more heart shaped dwelling. FIG. 1D shows two separate dwellings 105 within a single satellite image. A system for dwelling detection must be able to detect both dwellings, and not only one of them. FIG. 1E shows a first dwelling 106 with a second dwelling wall 107 attached to the outside. The exemplary satellite images may indicate the variety of dwelling shapes. A system for dwelling detection should detect dwellings in any of the examples shown in FIGS. 1A to 1E.

A dwelling may comprise an outer wall, which may be made from rough bushes. Other structures such as shelters or trees may be present within the outer wall. At the center of the dwelling may be bushes forming an inner circle where cattle may stay. The outer shape of the outer wall may be circular, square, or open ended. The contrast of the bushes with the environment may increase the difficulty of noticing the dwelling.

The number and locations of rural communities living in dwellings may be difficult to quantify or find, due to their dispersion over a large area. Satellite images, obtained by satellites in Earth's orbit, may use cameras to capture images of the earth's surface. These satellite images may assist with a range of geographical problems.

The method and system provided may use satellite images to detect dwellings. More specifically, they may be used to detect dwellings in large swaths of remote areas that may be difficult to access over land, or for which no maps or infrastructure plans exists. Satellite images may be obtained through online satellite image services, such as Google Earth Engine™ or Copernicus Satellites™. Dwelling detection for resource provisioning may therefore be executed very rapidly over large swatch of remote areas that would otherwise take months to cover.

The method and system provided may be used to identify living locations of dwellings from satellite images, without any knowledge of infrastructure or roads. The identified living locations may be used to create an output map of dwellings. The identified locations may be usable to determine a population density distribution. The population density distribution may further be usable to determine an optimal water harvesting solution.

The method and system may include using a model to detect if a dwelling is present in a satellite image. The model may be a computer vision model, configured and trained, to detect if a dwelling is present in a satellite image. The method may include obtaining a set of satellite images usable to train and validate the model. The set of satellite images may be processed for the purpose of obtaining improved satellite image data for training the model.

A dwelling detector may obtain training and validation data to configure, train, and validate a model. The model may be usable by repeatedly inputting individual satellite images into the model and obtaining an output. The output may be a probability or confidence value of if a dwelling is present in the satellite image or not. The model may output a dwelling location of a dwelling if the model determines that a dwelling is present in the satellite image.

The model output may be used to provision a resource to the dwelling. The resource may be any one of or combination of the group of: a water supply unit; a healthcare unit, a drone delivery dispatch, a warning service, a flood management service, a crop growth determining service, a water pipeline planning service, or a vegetation impact assessment service. The water supply unit may be a water harvesting unit. The water harvesting unit may be a storage tank capable of storing water in the rain season for use in the dry season. The healthcare unit may be a mobile clinic for treating and tending to the medical needs of the communities. The drone delivery dispatch may be a drone delivery service, configured to deliver goods or products such as medicines or vital goods, to communities in areas difficult to reach over land.

Outputting the model output of the dwelling detector of whether a dwelling is present in the satellite image may include outputting the dwelling location for provisioning of the resource, which may include transmitting an instruction to deploy the resource at or to or proximate the dwelling location. The instruction may be transmitted directly to a resource service provider, including the dwelling location.

The dwelling location output may be stored in a database for further post-processing. Once a series of satellite images have been evaluated and multiple dwelling locations have been stored in the database, a clustering algorithm may be used to cluster groups of dwelling locations that are located near to each other. A temporal analysis may be performed at dwelling locations over a period of time to determine if any dwellings are constructed or demolished. The post-processing and analysis may be usable to determine an optimal resource to be provisioned to the dwelling location. The dwellings in a single cluster, as output by the clustering algorithm, may be served by a shared resource.

Provisioning a resource may include any one or more of: transmitting an instruction to a provisioning entity; preparing a water harvesting unit, healthcare unit, or a drone for delivery dispatch; transporting and/or installing a water harvesting unit or a healthcare unit; and, dispatching a drone for a drone delivery. Efficient provision of resources may therefore be enabled.

FIG. 2A is a schematic diagram which illustrates an exemplary system 200 for detecting a dwelling in satellite image data for resource provisioning in rural settlements according to aspects of the present disclosure. The system 200 may include multiple databases 205,220,240 and a dwelling detector 201 which may be provided by or implemented on one or more computing devices. The dwelling detector 201 may be configured to determine if a dwelling is present in a satellite image.

A satellite image database 205 may store satellite image data 202. The satellite image data 202 may comprise a set of satellite images comprising individual satellite images 203. Each satellite image 203 may include associated satellite image meta data 204. The satellite image meta data 204 may include one or more of: a time stamp of when the image was captured by a satellite, a geographical coordinate corresponding to a geographical area captured within the satellite image, a resolution of the satellite image, a pixel density of the satellite image, an orientation, and a camera model. A location of a satellite image may be a geographical coordinate of a center pixel of the satellite image, a predefined corner pixel of the satellite image, or the like. The geographical coordinate may be a pair of latitude and longitude coordinate values.

The satellite image 203 may have a predefined pixel size. The predefined pixel size may be 100 pixels by 100 pixels. A software script may be created to automatically augment all the satellite images to the predefined pixel size. Each pixel may represent a predefined size or area of land. The predefined size of land may be 1 meter by 1 meter. The satellite image 203 may be a raw RGB color image, comprising a red, green and blue color. The satellite image 203 may be a three-channel image comprising one image per color. Alternatively, the satellite image 203 may be a grayscale image.

The dwelling detector 201 may comprise any one or more of: an input processor 210, a model generator 211, an output processor 214, a temporal analyzer 254, and a clustering process 216. The dwelling detector 201 may interact with a model database 220 and a dwelling database 240.

The dwelling detector 201 and the dwelling database 240 may interact with a resource provisioning unit 250.

The input processor may process the satellite image data 202, including a plurality of satellite images 203, to form a training data 202A and a validation data 202B. The processing of the satellite image data 202 to form the training data 202A may include compiling the training data 202A to include satellite images where dwellings are present in the satellite image. Additionally, the training data 202A may also include satellite images where no dwellings are present in the satellite image 203. Including satellite images without dwellings may be advantageous in training a supervised learning model. Different types of learning models are discussed further in the disclosure.

Compiling the training data 202A may include replicating each satellite image 203 of a dwelling a predetermined number of times to create replica satellite images from an original satellite image. Each replica may be rotated to an orientation which is different from the original satellite image of the dwelling. In some examples, three predetermined replicas may be created, and each may be rotated by one of: 90 degrees; 180 degrees and 270 degrees relative to the original satellite image of the dwelling. In some examples, the images may be rotated by a non-square angle (not 90, 180 or 270 degrees). When an image is rotated by the non-square angle, a mapping function may be used to map the image onto an image with the same resolution as the other satellite images.

The model generator 211 may be configured to generate a model 212. The model may, for example, be an image classifier. The model may be configured to receive a satellite image as an input and output whether a dwelling is present in the image. The model may be a neural network model. The neural network model may be a convolutional neural network (CNN). An exemplary architecture of a CNN is described in greater detail below with reference to FIG. 5.

The output processor 214 may receive an output from the model. The output processor 214 may process the output of the model to generate a dwelling location 241. Each satellite image 203 input into the model may have an associated dwelling location 241. The dwelling location 241 may include if a dwelling is present in a satellite image 203. The dwelling location 241 may include a geographical location 242, which may include the geographical coordinate corresponding to a geographical area captured within the satellite image. The dwelling location 241 may include a time stamp 243 of when the satellite image 203 of the dwelling location 241 was captured by a satellite. Additionally, the dwelling location 241 may indicate the presence or absence of a resource. The dwelling location 241 may include a resource instruction 244 to be used for provisioning of a resource.

The resource provisioning unit 250 may use the dwelling location 241 output for provisioning a resource. The dwelling location 241 may be usable by a water consumption estimator 251 to estimate a water consumption value at a dwelling in the satellite image 203. For example, the water consumption estimator 251 may include a data set of water consumption per unit size of a dwelling. The water consumption estimator 251 may determine a size the dwelling from the dwelling location 241 and/or resource instruction 244 to estimate an amount of water usage for the dwelling. A water unit calculator 252 may calculate a suitable water harvesting unit based on a water consumption estimator 251 value. Calculating a suitable water harvesting unit may include determining a type of water harvesting unit in association with the dwelling location.

The dwelling location 241 may be stored in the dwelling database 240. The dwelling database 240 may store a plurality of dwelling locations, each corresponding to a unique satellite image input into the model 212. The dwelling database 240 may store the dwelling location if a dwelling is present in the satellite image 203.

The clustering process 216 may include a clustering algorithm. The clustering algorithm may access a plurality of dwelling locations 241 from the dwelling database to perform a clustering of dwelling locations. The clustering algorithm may be a K-means clustering algorithm. The clustering algorithm may create a plurality of clusters comprising multiple dwelling locations within each cluster. The results of the clustering algorithm may be stored in the dwelling database 240 as a clustering of dwellings 245. The clustering of dwellings 245 may comprise a list of dwelling locations 241 within each cluster. The clustering of dwellings 245 may comprise a cluster location associated with the clustering. The list of dwelling locations within all clusters determined by the clustering algorithm may form a subset of all dwelling locations in the dwelling database 240. Therefore, not every dwelling location 241 may be in a cluster. The clustering process 216 may output a density map. The density map may indicate how close different clusters of dwellings are from each other. The density map may be usable to determine a population density.

The temporal analyzer 254 may perform a temporal analysis of satellite images 203 that have the same geographical location 242, but different time stamps 243. The temporal analysis results may indicate if dwelling has moved from a known location, or if a new dwelling has been constructed at a location where previously no dwelling was present. The temporal analyzer 254 may generate an updated dwelling location for each of the satellite images. The temporal analyzer 254 may output a new set of dwelling locations and an updated clustering of dwellings. For example, an updated set of satellite images may be obtained covering an overlapping area as the satellite image data 202.

The model 212 may be trained using the training data 202A. The model 212 may include a model architecture which may be stored as model parameters 221 in the model database 220. The model parameters 221 may define the type and structure of the model. The model 212 may include a set of weights 222. The set of weights may be a set of internal variables of the model 212. The training procedure generates a set of weights 222 associated with the model architecture and model parameters 221, which may be stored in the model database 220. In some examples, the model database 220 may be part of the dwelling detector. In other examples, the model database 220 may be a cloud storage or an external storage database.

The model may be generated and trained within a first environment. The first environment may be a service provided for generating and training a model. An exemplary first environment may be a service such as Google Colab™. The model may be generated and trained using Tensorflow™, OpenCV™, or YOLOv7™. YOLOv7™ may be highly optimized for speed and accuracy with minimal background detection errors. YOLOv7™ may perform inadequately with dwellings of varying sizes and shapes. Tensorflow™ is an open-source tool and is compatible with Python and JavaScript, allowing for integration with Google Earth Engine™.

The model may be an image classification model, configured to output whether an object (such as a dwelling) is detected within the image. For example, the model may output a probability of whether a dwelling is present in the image and/or a probability of whether there is no dwelling detected in the image. Alternatively, the model may be an object detection model, configured to detect where an object is with an image. The image classification model may detect whether a dwelling is present within a satellite image, whereas the object detection model may detect where within a satellite image a dwelling is. An output from the object detection model may include a highlighted region where the dwelling is detected.

The first environment may include or have access to the satellite image database 205 with satellite images to be used for generating training data 202A and validation data 202B. The first environment may be a personal computer which may include a graphical processing unit, be a high-performance computing system provided by an external provider, or the like.

FIG. 2B is a schematic diagram which illustrates an example system 260 in which the dwelling detector and/or model of FIG. 2A are deployed within a satellite image data environment 261 for detecting dwellings according to aspects of the present disclosure. The satellite image data environment 261 may be a different environment to that in which the model is trained (e.g. being a first environment). The satellite image data environment 261 may be Google Earth Engine™.

The model 212 may be executable within the dwelling detector 201 within the satellite image data environment 261. The satellite image data environment 261 may include or have access to an environment satellite image database 265. The environment satellite image database 265 may include satellite images obtained to cover a predefined geographical area. The satellite image data environment 261 may obtain the model parameters 221 and set of weights 222 for the model 212 from the model database 220. The satellite image data environment 261 may output dwelling location 241 outputs to the dwelling database 240. The model database 220 and the dwelling database 240 may reside in an off-environment storage 270 such as a cloud storage service.

The system 200 and 260 described above may implement a method for dwelling detection in satellite image data using a model. FIG. 3A is a flow diagram which illustrates an example method for training a model for detecting dwellings in satellite images, according to aspects of the present disclosure. In some examples, the method of FIG. 3A may be performed in the first environment being provided by a computing device.

FIG. 4A is an illustration of an exemplary topographical map 400 and a predefined geographical area 402. When training the model 212, a predefined area 402 may be selected from the topographical area 400, from which satellite images may be obtained.

Training the model 212 may include accessing 301 the satellite image data 202 from the satellite image database 205. The satellite image data 202 may include a set of satellite images. The satellite images may form a complete covering of the predefined area 402 such that there are no missing areas. Multiple sets of satellite images may be available for a particular location as multiple satellites may pass over the location at multiple points in time, forming a large set of satellite images of varying quality. The satellite images may overlap with each other to prevent the case that a dwelling is divided over two adjacent satellite images and would negatively influence the training.

Image stacking may be performed, whereby an image stack is generated from the multiple sets of satellite images. The image stack may be divided into slices of images that cover the predefined area 402. Each slice may include images obtained from various satellites, at varying resolutions.

Satellite images captured by a satellite during a single pass over an area may result in at least some images being unsuitable for training or for using the model. Factors such as image focus, low-resolution, or cloud cover may occur. This may result in holes or gaps in satellite image coverage across an area or low-resolution satellite images within the predefined area. Therefore, it is necessary to use satellite images gathered over a short period of time, such as over a range of up to four weeks, and regard the satellite images of being representative of a single point in time, or time stamp. The time stamp may be a range of time. This may allow for temporal analysis to be performed by comparing satellite images across different time stamps, where the range of time that the satellite images were captured do not overlap.

Satellite images within the image stack may be sorted according to any one of the group of: band type, central wavelength, bandwidth, spatial resolution, and objective. The objective may include any of the group of: aerosol correction, land measurement band, water vapor correction, and cirrus detection. The band type may be a visible near infrared (VNIR) or a short-wave infrared spectroscopy (SWIR). The image stack may include images which may be a combination of all collected wavelengths of color light. The image stack may include images from both the VNIR and SWIT band types.

The satellite image data environment 261 may squash high-resolution sections, gathered over a short period of time, together to generate a full high-resolution satellite image coverage of the predefined area 402 from which satellite image data may be obtained. Squashing may compile a single slice that covers the predefined area 402, comprising the best satellite images from which to train the model or use in application of the model. For example, this may include ranking each satellite image within each slice of the image stack. The ranking may assign a high rank to a satellite image with no-cloud coverage, and a low rank to a satellite image with cloud coverage. Squashing may include combining the highest ranked satellite image at a location from across the image stack. This may be performed for each satellite image at each location to form the compiled single slice. Squashing may limit images with cloud coverage or low-resolution from being used in training.

The set of satellite images may be processed 302. The processing 302 may include forming a training data 202A and a validation data 202B. The processing 302 of the set of satellite images may include augmenting the satellite images by performing any one or more of the group of: rotating, cropping, flipping, varying a resolution, varying a size scale, varying a color scale, varying a pixel size, or varying a contrast.

To achieve a suitable accuracy for training the model, the processing may filter satellite images according to the resolution. For example, any satellite image with a resolution of 10 to 20 meters per pixel may be filtered from the set of satellite images.

The processing may include creating three replicas of each satellite image. Each replica may be rotated by: 90, 180, and 270 degrees respectively relative to the original satellite image to create three additional satellite images, different from the original image and different to each other. This creates a larger training data 202A set. Additionally, replicas of the original satellite images may be flipped along either or both of a horizontal or vertical axis to create a mirror image of the original satellite image. In some examples, when rotating the images by the non-square angle, an axis of the rotated image may not align with an axis of an input into the model. A mapping step may map the image with a rotated axis to an image with an identical axis to the input. The mapping step may be a linear interpolation, polynomial interpolation, or other higher-order mapping techniques.

Processing 302 the set of satellite images may include manually inspecting each satellite image to label said image. Labelling each satellite image may include manually classifying each image for if a dwelling is present in said image or not. Satellite images where cloud cover is prevalent, or the resolution is too low may manually be removed.

The model generator 211 may generate 303 a model 212. Generating 303 the model may include generating a model that is configurable through training to detect if a dwelling is present in the satellite image. Generating 303 the model may include generating a set of parameters defining the model type and model architecture. An exemplary model 212 that may be generated 303 is described below with reference to FIG. 5.

The model 212 may be trained 304 using the training data 202A. Training 304 the model 212 may include a training procedure whereby the weights of the model are adjusted. Training 304 the model may result in a trained model being output from the training process for further testing. A training procedure for training the model is described in greater detail below with reference to FIG. 6. For example, approximately 2500 unique satellite images may be used for training. Of the 2500 unique satellite images, 2000 may include a dwelling and 500 may not include a dwelling within the image. In some examples, the orientation of the unique satellite images may be augmented by rotating the images at least 3 times to create a total of 8000 images.

The trained model may be validated 305 using the validation data 202B. Validating 305 the trained model may include determining an accuracy of the model for correctly determining if a dwelling is present in the satellite images of the validation data 202B. The validation data may be different to the training data. Having the validation data being different from the training data may be necessary such that the model is not over-fitted to the training data after training the model. An over-fitted model is a model that maps the input to the output of the training data, but without having determined features of the training data such that it is usable on other input data. The validation data serves as a test to determine the accuracy of the model with new data.

The trained and validated model may be output 306 to be usable in determining if a dwelling is present in a satellite image. The trained and validated model may be stored 307 in a model database 220. Storing the trained and validated model may include storing the model weights 222 and model parameters 221.

The model 212 as stored in the model database may be deployable to a satellite image data environment. The trained model may be usable for satellite images that are not part of the training data or validation data.

FIG. 3B is a flow diagram which illustrates an example method for detecting a dwelling in satellite image data for resource provisioning in rural settlements, according to aspects of the present disclosure. The method may be conducted in a satellite image data environment provided by a computing device. The method may include receiving 351 a geographical area of interest to be inspected for dwellings. The geographical area of interest may be a predefined geographical area 402. The geographical area of interest may be defined as a latitude and longitude position of a point within the geographical area of interest and a width and a height of the area of interest. Alternatively, the geographical area of interest may be defined as a boundary including a combination of latitude and longitude values.

The geographical area of interest may be used to access 352 satellite image data relating to (e.g., covering or capturing) the area of interest. The satellite image data may be an environment satellite image data 262, available in an environment satellite image database 265 within the satellite image data environment 261. The environment satellite image database 265 may comprise satellite images unavailable during training of the model.

FIG. 4B is an illustration of an exemplary topographical map and a predefined geographical area, and multiple satellite images covering the predefined geographical area. Satellite images may be obtained 353 from the satellite image data. Obtaining 353 satellite images may include defining smaller regions to obtain a series of satellite images from the satellite image data. Each satellite image, of a predefined size, may be obtained by repeatedly selecting images at a plurality of geographical locations. The series of satellite images across the plurality of geographical locations may, when combined, form a complete covering of the geographical area of interest.

In some examples, the set of satellite images may be selected from an image stack created from a plurality of satellite images at each location, selecting the highest resolution images. In other examples, all satellite images across the image stack may be selected to input into the trained model.

The series of satellite images across the plurality of geographical locations may partially overlap with each other, forming overlapping satellite images 404,406,408,410. The partial overlap may ensure that if a dwelling at an edge of the satellite image, and potentially not recognizable by the model, may fall near a center of an adjacent satellite image. For example, the satellite images may overlap by approximately 20 pixels.

For example, the predefined area may be 260 square miles with a final image stack of 10980 pixels by 10980 pixels.

Each satellite image obtained may be associated with a geographical coordinate. The geographical coordinate may be a latitude or longitude value of the center of the satellite image or other point within the image. The geographical coordinate may be a boundary provided in latitude and longitude coordinates.

When combined, all satellite images within the geographical area of interest may form a complete covering, such that no point within the geographical area of interest does not coincide with at least one satellite image.

Each satellite image within the geographical area of interest made be input 354 into the trained model. Inputting the satellite image into the trained model may include formatting the satellite image into three images for each of three input channels, each corresponding to one of the RGB colors.

The trained model may output 355 a classification of if a dwelling is present in the satellite image or not. If the classification is positive (that a dwelling is present in the satellite image), a dwelling location indicating a dwelling is present may be stored 356 in the dwelling database. If the classification is negative (that a dwelling is not present in the satellite image), the dwelling location indicating that no dwelling is present may be stored 356 in the dwelling database. The negative classification may be determined if the probability of whether a dwelling is present is below a pre-determined value. For example, the classification of a dwelling being present in a satellite image may be above an 80% confidence (probability) value.

The dwelling location may include a location associated with the satellite image that was input into the trained model. The dwelling location may be stored 356 with a corresponding time stamp. The time stamp may indicate when the satellite image was captured by the satellite. The dwelling location may be usable for overlaying the coordinates over the image stack and predefined area.

Outputting the classification may include outputting the classification with the dwelling location. Outputting the dwelling location may include outputting the dwelling location for provisioning of a resource to the dwelling location.

The dwelling database may indicate if a resource is provisioned at the dwelling location. Outputting the dwelling location may include outputting the dwelling location when the absence of a resource is indicated at the dwelling location.

Each satellite image obtained from the set of satellite images may be input into the trained model. Each classification and dwelling location output, associated with each input, may be stored in the dwelling database. By inputting each satellite image into the trained model, a classification of dwellings across the entire geographical area of interest may be generated.

A clustering analysis may be performed 357 using a plurality of dwelling locations. The plurality of dwelling locations may be obtained by retrieving each dwelling location in the dwelling database and compiling the plurality of dwelling locations. The plurality of dwelling locations may be input into the clustering algorithm. The clustering algorithm may determine a clustering of dwellings. Each clustering of dwellings may comprise a list of dwellings that fall within a specific cluster. The clustering of dwellings and in some cases a cluster location associated with the clustering may be output and stored in the dwelling database.

As the number and location of dwellings may vary over time, a temporal analysis may be performed 358. The dwelling detector may obtain an updated set of satellite images. The updated set of satellite images may be images that are captured by a satellite at a time after the original set of satellite images. The updated set of satellite images may cover the same geographical area of interest as the original set of satellite images.

An updated satellite image, obtained from the updated set of satellite images, may be input into the trained model. A plurality of updated satellite images may be input into the trained model. Each of the updated satellite images may include a time stamp. The time stamp may be output with an updated classification and stored in an updated dwelling location. The updated dwelling location may store the location of the updated satellite image.

The temporal analysis may be performed by comparing the updated dwelling location with the original dwelling location for the same location. The updated dwelling locations may be usable in determining an updated clustering of dwellings.

A resource may be provisioned 360 based on the clustering and temporal analysis. For example, if a dwelling is detected in an image, the image may be provided to the water consumption estimator 251 and/or the water unit calculator 252. Providing the image to the water consumption estimator 251 and/or the water unit calculator 252 may be usable for provisioning a resource, such as a water harvesting unit. Provisioning the resource may include determining an instruction to provision a resource. For example, a signal may be output indicating a type of water harvesting unit to be provisioned to a specific dwelling location. In some examples, provisioning 360 a resource may include transporting the resource to and/or installing the resource at the dwelling location. In some examples, provisioning 360 a resource may include dispatching a drone to the dwelling location for delivery.

FIG. 5 is a schematic diagram which illustrates an example CNN architecture. A CNN architecture type model may fall under the category of artificial intelligence (AI), such as an AI model. The terms artificial intelligence (AI), machine learning, and deep learning may be used interchangeably throughout this disclosure when referring to trained AI models. Machine learning may be considered a sub-branch of AI and deep learning may be considered a sub-branch of machine learning. Deep learning is a form of machine learning that uses a layered network, referred to as an artificial neural network (ANN). Any AI, machine learning and deep learning system may rely on an underlying model. The model may be tailored to a specific use case. Although AI is considered the broadest of term, it is common that any AI system includes some form of machine learning, with some systems further including deep learning.

Some examples of machine learning models may include, but are not limited to: decision trees, random forest regression, support-vector machines, K-means clustering, regression analysis, Gaussian processes, and the like.

Machine learning models (as well as deep learning models) may be categorised into classification or regression. Classification models may classify an input into one or more of a set of classifications, with the output being one of discrete classifications. Regression models may determine an output that may be a value or output across a continuous output range. A regression model may estimate a relationship between an input to an output.

ANNs may include a variety of structures, which are referred to as architectures. Different architectures are suitable for different use cases. Examples of ANN architectures may include convolutional neural networks or recurrent neural networks. Convolutional neural networks may be suitable for image-based data or multi-dimensional input data. Recurrent neural networks, such as long-short term memory networks, may be more suitable for time series applications.

An ANN may consist of interconnected units, commonly referred to as neurons, as they are inspired by and resemble neurons of the brain. The units may be made up of nodes and edges forming a connected network. The edges may connect nodes together. ANNs may be configured in the form of a layered structure with an input at the first layer and an output provided by the final layer. The layers between the first layer and final layer are hidden layers.

The input layer may include one or more nodes. An edge may extend from each node. Each edge may be connected to a node in a subsequent hidden or output layer. Each node may include more than one edge that connects the node to a plurality of other nodes in other layers. In some examples, an edge may feed back into a previous node in a preceding layer (a node not in subsequent layers but in a further layer), or to a different node in the same layer. In the example of FIG. 5, the input layer may include a resizing layer 502 where the input 501 is input into the model.

The output of a node may be computed by an activation function, which may be a linear or a non-linear function of the sum of the inputs into each node in each layer. The output value of each node in the preceding layer is multiplied by a weighting value, which determines the strength of each nodes'output value. Finally, the value that is determined at the node(s) of the final layer is the output of the ANN. For regression type ANNs, the output may contain only a single node with a value, or many nodes. For classification type ANNs, the output may include multiple nodes, where each node is an output of the probability of a classification type. Referring to FIG. 5, the probability is shown by the dwelling probability 512 and the not dwelling probability 513.

More complex ANNs are better suited to specific tasks. In addition to the weights and activation functions of a regular ANN, a CNN applies a filter (or a kernel) onto a two-dimensional data structure, which may reduce the number of edges between the hidden layers in the neural network. This may in turn reduce the number of weights within the neural network. A CNN may find application in image-based tasks, where image data may be structured as a two-dimensional data structure. A CNN may be extended into further dimensions by increasing the dimensions of the filter/kernel to match the number of dimensions of the input data.

Recurrent neural networks include a recurrent unit. This recurrent unit may maintain a hidden state over time, thereby providing a pseudo-memory capability. Such models may find application in time series or sequential operations, such as speech or text. Multiple recurrent units may be connected to each other, where the output of one unit at a first timestep may be used as an input into another recurrent unit at a second timestep. Examples of recurrent neural networks include, but are not limited to, long short-term memory networks, and gated recurrent units. Transformers are another form of deep learning architectures well suited for sequential based data. Transformers may utilise a self-attention mechanism instead of recurrence (such as in a recurrent neural network).

The satellite image input into the model may comprise three color images, being an RGB image. The model may include three input channels 501, one for each of the RGB colors. In an example, each of the three input channels may be an image of 100 pixels by 100 pixels. The input may first pass through a resizing layer 502. The resizing layer may rescale the input to values between 0 and 1. Rescaling normalizes the input value, improving model accuracy and improving model training.

The resized input may pass through three sets of convolution layers 503,505,507 and pooling layers 504,506,508. Each convolutional layer applies a filter to the incoming image into the layer. Each convolutional layer may highlight features, such as edges, textures, or patterns. In an example, the convolutional layers may filter circular or closed shapes similar to the dwellings of FIG. 1A to 1E.

Each pooling layer 504,506,508, which each may be a max pooling layer, may reduce the size of the filtered image from the upstream convolutional layer. The max pooling layer reduces the size of the filtered image while retaining the most prominent features. This may improve model speed and performance.

The output of the final pooling layer may pass through a flattening 509 layer. The flattening 509 layer may convert a plurality of 2-dimensional channels into a single dense layer for a feedforward network. An example may be a 1-dimensional vector. The output of the flattening 509 layer may pass through a first dense layer A 510 and a second dense layer B 511. The first dense layer A 510 may transform the flattened layer through a rectified linear unit (ReLU) layer. In an example, the vector size at the after the first dense layer A may be 128 numbers. This may help capture relationships between filtered features. The second dense layer B 511 may receive the first dense layer A output as an input, and output only two channels. The output channels may be a dwelling probability 512 channel and a not dwelling probability 513 channel. The output channel with the largest probability may indicate if a dwelling is present or not in the satellite image.

Alternatively, the final output may only be a single output channel indicating only the dwelling probability. The single output channel may range from 0 to 1. The output may be a probability of a dwelling being present in the satellite image if the probability is above a predefined threshold, with 0 being that no dwelling is present and 1 being a dwelling is present in the satellite image.

The exact structure of the CNN, such as the number and size of the convolutional layers, pooling layers and dense layers may be defined in the model parameters 221. In an example, the CNN may comprise 1 resizing layer, 3 convolutional layers, 3 pooling layers, 1 flattening layer, and 2 dense layers. The convolutional layers and dense layers may include the set of weights 222 that are varied during training.

Alternatively, in other examples, the satellite image may be a grayscale image. The CNN may have only one input channel for the grayscale image.

FIG. 6 is a flow diagram of an exemplary training procedure 600 for training the model 212. The training procedure 600 requires access to raw incoming data 610 for training. The raw incoming data 610 may be the set of satellite images. The raw incoming data 610 may be input into a data preparation process 611. The data preparation process may include processing 302 the raw incoming data 610. The data preparation process 611 may format the raw incoming data 610 to prepare a training data 612. The prepared training data 612 may be the training data 202A formed by the input processor 210.

A training process 613 receives the training data 612. The training process 613 may iteratively update the model 212 until a predefined quality criteria and accuracy criteria are achieved. The model, such as the CNN model, may use backpropagation within the training process 613 to vary the model weights 222. The training process 613 may be a supervised learning process. The training process 613 may include a loss function to determine the difference between the model output and the known output which is the training data. The training process 613 may be performed in the first environment. The output of the training process 613 is a trained model 212.

Supervised learning may require labelled training data 612, such that a correct output is known for each training data input. The task of the training process 613 is to minimize the difference (or error) between the output of the model 212 and the known output, for example due to the labelling, of the training data 612. In some examples, the output may be verified as the output must satisfy a provided formula, such as with physics-informed models. The training procedure modifies the model 212 such that the difference (or error) is minimized. Unsupervised learning may be configured to extract features or patterns from unlabelled data. Unsupervised learning may be used when the raw incoming data 610 is too large to be labelled. For example, unsupervised learning may be used for auto-encoders, where the aim is for the model output to match the model input by encoding the input data, and decoding the encoded input data.

An example implementation of the system and method described herein was deployed for the detection of dwellings in the form of bomas of the Maasai people of Northern Tanzania. In the example implementation, the accuracy, as defined by the loss function, was initially approximately 30% when no replicas of the original satellite images were created and rotated or flipped. The training data without replicas included 2,000 satellite images with a dwelling present, and 500 satellite images without a dwelling present. By including the rotated and flipped replicas, and hence increasing the training data, the model accuracy increased up to 93% when tested with non-training data. In this way, the total number of training satellite images increased from 2,500 to 10,000 images. The 10,000 satellite images included 8,000 satellite images with a dwelling present, and 2,000 satellite images without a dwelling present.

Training the model includes multiple backpropagation iterations, called epochs. In the example implementation, the model accuracy plateaued after 15 epochs at approximately 97% accuracy. The model may plateau due to the shape, color, or size variation of the dwellings. Toggling filters, cropping, using a single grayscale input, or increasing the contrast did not impact the accuracy of the trained model.

The trained model 212 may be deployable to a different environment to the first environment, such as the satellite image data environment 261. The trained model 212 may be usable in a runtime process 622. The runtime process 622 may accept input data 621 to determine an output data 623. The runtime process 622 may accept a sequence of input data 621. The computation of the runtime process 622 may be referred to as ‘inference’.

The input data 621 may be a sequence of satellite images that cover a predefined area 402. The runtime process 622 may include the model 212 being repeatedly queried with each satellite image from the sequence of satellite images. The output data 623 may be usable by a downstream process 624. The downstream process 624 may be a post-processing functionality of the model output. For example, the downstream process may be the resource provisioning unit 250.

FIG. 7 is an illustration of an exemplary topographical map with a plurality of dwelling locations clustered into multiple clusters. The coordinates from the dwelling locations may be used to overlay dwelling locations onto a map.

The clusters may be output from the clustering algorithm. The clusters may be divided into clusters without a resource 702 or clusters with a resource 701. Each dwelling location may be associated with a specific location 703,704 of a dwelling. Some dwellings may be placed into a cluster 704. Some dwellings may not be placed into a cluster 703. The number of dwelling locations for each cluster may be configurable. For example, each cluster may include approximately 20 dwelling locations. The clustering analysis may segment each cluster into categories. For example, the categories may be any one of the group of: high-density, medium-density, or low-density.

Outputting a dwelling location for provisioning of a resource to the dwelling may include outputting a cluster location associated with or determined from the clustering of dwellings. The output of the clustering of dwellings may be used in determining a water consumption estimation of the dwellings within each of the clustering of dwellings. The water consumption estimation may be usable in determining a water harvesting unit size according to the water consumption estimation.

The water consumption estimation may determine a type of water harvesting unit sized according to the water consumption estimation. An indication of the type of water harvesting unit may be output in association with the dwelling location. The output may be in the form of an instruction to provision the resource in the form of the type (e.g., including size) of water harvesting unit at the dwelling location.

The clustering of dwelling locations may indicate that large populations live in dense clusters 705,706,701,712,713 of several dozen dwellings. They may also live in lines along the edges of major geological formations such as dried riverbeds, indicated by clusters 707,709,711. In addition, some clusters 704,710 are located parallel to a major highway. The topographical map output with overlays of dwellings may help to segment the areas to focus on best placing various water harvesting units. Larger groups, especially away from natural water bodies such as clusters 705,706,701 may be prioritized based on experimental results.

Various components may be provided for implementing the method described above with reference to FIGS. 3A and 3B. FIG. 8 is a block diagram which illustrates exemplary components which may be provided by a system 200 for detecting a dwelling in satellite image data for resource provisioning in rural settlements according to aspects of the present disclosure. The system 200 may include a processor 842 for executing the functions of components described below, which may be provided by hardware or by software units executing in the system 200. The software units may be stored in a memory component 844 and instructions may be provided to the processor 842 to carry out the functionality of the described components. In some cases, for example in a cloud computing implementation, software units arranged to manage and/or process data may be provided remotely.

The system may include a dwelling detector 201. The dwelling detector 201 may include an inference system 800. The inference system 800 may include a satellite data accessing component 802 arranged to access satellite image data and obtain satellite images from the satellite image data. The satellite image data may be accessed from the satellite database. The satellite data accessing component 802 may obtain a set of satellite images that cover the geographical area of interest. The satellite images may partially overlap to form a complete covering of the geographical area of interest.

The inference system 800 may include an image input component 803 arranged to input a satellite image into the trained model. The trained model may output a classification of if a dwelling is present in the satellite image. The image input component 803 may format the incoming satellite image into a format suitable for the specific model input 501. The image input component 803 may separate the input satellite image into three RGB channels to be input into a CNN. The image input component 803 may generate a sequence of input images to be input sequentially into the model.

The inference system 800 may include a location outputting component 804 arranged to output a dwelling location associated with the input satellite image. The location outputting component 804 may be arranged to output the dwelling location for provisioning of a resource to the dwelling, wherein outputting the dwelling location includes outputting a cluster location for a clustering of dwellings The location outputting component 804 may output a classification associated with the dwelling location. The location outputting component 804 may output a time stamp of the input satellite image associated with the dwelling location.

The inference system 800 may include a location storing component 805 arranged to store a dwelling location output from the trained model in the dwelling database. The dwelling classification may be stored and associated with the corresponding dwelling location. The location storing component 805 may store a clustering of dwellings, wherein each dwelling location may be associated with a cluster and/or a cluster location determined for the cluster. The location storing component 805 may store the dwelling locations and/or cluster location according to a time stamp.

The inference system 800 may include a resource provisioning component 806 arranged to provision a resource to the dwelling. The resource provisioning component 806 may determine whether a resource is already present at a dwelling location. The resource provisioning component 806 may determine a type of resource to be provisioned at a dwelling location. The resource provisioning component 806 may communicate, to a resource provider, a location of where a resource is to be provisioned and what type of resource. The resource provisioning component 806 may be arranged to, in provisioning a resource, transmit and instruction for provisioning a resource.

The dwelling detector 201 may include a training system 820. The training system 820 may include an image accessing component 821 arranged to access satellite image data. The image accessing component 821 may access images from a satellite database. The training system 820 may include an image obtaining component 822 arranged to obtain a set of satellite images and satellite image meta data from the satellite image data. The image obtaining component 822 may be arranged to obtain a satellite image from the satellite image data.

The training system 820 may include an image processing component 823 arranged to process a set of satellite images. The image processing component 823 may be arranged to form training data and validation data from the set of satellite images.

The training system 820 may include a model generating component 824 arranged to generate a model, configured through training, to determine whether a dwelling is present in the satellite image. The model generating component 824 may be arranged to generate model parameters and model weights according to the specific model type and architecture.

The training system 820 may include a model training component 825 arranged to train the model using the training data to obtain the trained model. The model training component 825 may be arranged to vary the weights of the model during training.

The training system 820 may include a model validation component 826 arranged to validate the trained model using the validation data. The model validation component 826 may be arranged to determine a trained model accuracy.

The training system 820 may include a model outputting component 827 arranged to output the trained model. The training system 820 may include a model storing component 828 arranged to store the trained model in a model database. The model storing component 828 may store the model parameters and model weights in the model database.

The dwelling detector 201 may include a clustering component 854 arranged to perform a clustering of dwelling locations. The clustering component 854 may access the dwelling database to obtain the dwelling locations. The clustering component 854 may store the clustering of dwellings in the dwelling database. The clustering component 854 may be arranged to perform a clustering using a plurality of dwelling locations obtained by retrieving dwelling locations stored in the dwelling database. The clustering component may output a clustering location determined from and/or associated with the clustering.

The dwelling detector 201 may include a temporal analysis component 852 arranged to perform temporal analysis of the dwelling locations. The temporal analysis component 852 may determine changes to the presence of a dwelling at a geographical location. The temporal analysis component 852 may access the dwelling database to obtain the dwelling locations.

FIG. 9 illustrates an example of a computing device 900 in which various aspects of the disclosure may be implemented. The computing device 900 may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device 900 may be suitable for storing and executing computer program code. The various participants and elements in the previously described system diagrams may use any suitable number of subsystems or components of the computing device 900 to facilitate the functions described herein. The computing device 900 may include subsystems or components interconnected via a communication infrastructure 905 (for example, a communications bus, a network, etc.). The computing device 900 may include one or more processors 910 and at least one memory component in the form of computer-readable media. The one or more processors 910 may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device 900 may be distributed over a number of physical locations (e.g. in a distributed, cluster or cloud-based computing configuration) and appropriate software units may be arranged to manage and/or process data on behalf of remote devices.

The memory components may include system memory 915, which may include read only memory (ROM) and random access memory (RAM). A basic input/output system (BIOS) may be stored in ROM. System software may be stored in the system memory 915 including operating system software. The memory components may also include secondary memory 920. The secondary memory 920 may include a fixed disk 921, such as a hard disk drive, and, optionally, one or more storage interfaces 922 for interfacing with storage components 923, such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device 900 may include an external communications interface 930 for operation of the computing device 900 in a networked environment enabling transfer of data between multiple computing devices 900 and/or the Internet. Data transferred via the external communications interface 930 may be in the form of signals, which may be electronic, electromagnetic, optical, radio, or other types of signal. The external communications interface 930 may enable communication of data between the computing device 900 and other computing devices including servers and external storage facilities. Web services may be accessible by and/or from the computing device 900 via the communications interface 930.

The external communications interface 930 may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry.

The computer-readable media in the form of the various memory components may provide storage of computer-executable instructions, data structures, program modules, software units and other data. A computer program product may be provided by a computer-readable medium having stored computer-readable program code executable by the central processor 910. A computer program product may be provided by a non-transient or non-transitory computer-readable medium, or may be provided via a signal or other transient or transitory means via the communications interface 930.

Interconnection via the communication infrastructure 905 allows the one or more processors 910 to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device 900 either directly or via an I/O controller 935. One or more displays 945 (which may be touch-sensitive displays) may be coupled to or integrally formed with the computing device 900 via a display or video adapter 940.

The foregoing description has been presented for the purpose of illustration; it is not intended to be exhaustive or to limit the technology to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the examples in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the present disclosure be limited not by this detailed description, but rather by any claims that issue on an application based hereon. Accordingly, the present disclosure is intended to be illustrative, but not limiting, of the scope of any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A computer-implemented method for detecting a dwelling in satellite image data for resource provisioning in rural settlements, the method comprising:
accessing the satellite image data and obtaining a satellite image from the satellite image data;
inputting the satellite image into a trained model, wherein the trained model outputs a classification indicating whether a dwelling is present in the satellite image;
storing in a dwelling database, when the trained model outputs a classification indicating that a dwelling is present in the satellite image, a dwelling location based on a location associated with the satellite image;
performing a clustering using a plurality of dwelling locations, obtained by retrieving dwelling locations stored in the dwelling database, to determine a clustering of dwellings; and,
outputting the dwelling location for provisioning of a resource to the dwelling, including outputting a cluster location associated with the clustering of dwellings.

2. The method as claimed in claim 1, including:
accessing the satellite image data including a set of satellite images and satellite image meta data;
processing the set of satellite images to form a training dataset and a validation dataset of satellite images;
generating a model to determine whether a dwelling is present in the satellite image;
training the model using the training dataset to obtain a trained model;
validating the trained model using the validation dataset;
outputting the trained model; and,
storing the trained model in a model database.

3. The method as claimed in claim 2, wherein processing the set of satellite images to form a training dataset includes compiling the training dataset including satellite images of dwellings.

4. The method as claimed in claim 3, wherein compiling the training dataset includes replicating each satellite image of a dwelling a predetermined number of times and rotating each replica satellite image to an orientation which is different from an original satellite image of the dwelling and each other replica satellite image, and wherein the predetermined number of times is three and wherein each of the three replicas is rotated each of: 90 degrees; 180 degrees and 270 degrees relative to the original satellite image of the dwelling.

5. The method as claimed in claim 1, wherein the method includes obtaining a series of satellite images from the satellite image data and inputting each satellite image from the series of satellite images into the trained model and storing, for each satellite image from the series of satellite images in which the classification indicates that a dwelling is present, a dwelling location based on a location associated with that satellite image.

6. The method as claimed in claim 5, wherein the series of satellite images is determined based on a geographical area of interest, and wherein the method includes receiving input of the geographical area of interest and using the geographical area of interest to obtain the series of satellite images from the satellite image data.

7. The method as claimed in claim 1, wherein the model is a neural network.

8. The method as claimed in claim 7, wherein the neural network is a convolutional neural network comprising three input channels and two output channels, and wherein each output channel is a value ranging between 0 or 1, one output indicating the probability of a dwelling being present in the satellite image and the other output indicating no dwelling is present in the satellite image.

9. The method as claimed in claim 1, wherein the model is an image classifier that determines the probability that a dwelling is present in the satellite image.

10. The method as claimed in claim 1, including compiling the plurality of dwelling locations, as an input to a clustering algorithm to determine the clustering of dwellings, wherein each clustering of dwellings comprises a list of dwelling locations within said cluster.

11. The method as claimed in claim 10, wherein the clustering algorithm is a K-means clustering algorithm, and wherein a combination of all dwelling locations across all clusters forms a subset of all dwelling locations in the dwelling database.

12. The method as claimed in claim 1, including determining, in association with the dwelling location, a water consumption estimation and a type of water harvesting unit sized according to the water consumption estimation and outputting an indication of the type of water harvesting unit in association with the dwelling location.

13. The method as claimed in claim 1, including:
obtaining an updated set of satellite images, wherein the updated set of satellite images includes satellite images which are captured by a satellite at a later time than the images in the set of satellite images;
inputting at least one updated satellite image selected from the updated set of satellite images into the trained model; and,
storing, when the trained model output classification indicates that a dwelling exists in the updated satellite image, a location of the updated satellite image as an updated dwelling location in a dwelling database with a corresponding time stamp of when the updated satellite image was captured by a satellite.

14. The method as claimed in claim 13, wherein the method includes performing a temporal analysis of a variation of the dwelling locations using the updated dwelling locations to output a new set of dwelling locations and an updated clustering of dwellings.

15. The method as claimed in claim 1, wherein obtaining a set of satellite images includes obtaining the images from a satellite image database, repeatedly selecting images at a plurality of geographical locations of a predefined size and where a combination of all satellite images forms a complete covering of a predefined geographical area, and wherein at least a portion of satellite images within the set of satellite images partially overlap with each other.

16. The method as claimed in claim 1, wherein the processing of the set of satellite images includes augmenting the satellite images by performing any one of the group of: rotating, cropping, varying a resolution, varying a scale, varying a color scale, varying a pixel size, or varying a contrast.

17. The method as claimed in claim 1, wherein the satellite image is: 100 pixels by 100 pixels, each pixel representing one square meter, is a raw RGB color, and is a three channel image.

18. The method as claimed in claim 1, wherein the model is generated and trained in a first environment, and wherein the trained model is deployable to and executable within a satellite image data environment.

19. A system for detecting a dwelling in satellite image data for resource provisioning in rural settlements, the system comprising: a non-transitory computer-readable storage medium; and one or more processors coupled to the non-transitory computer-readable storage medium, wherein the non-transitory computer-readable storage medium comprises program instructions that, when executed on the one or more processors, cause the system to perform operations comprising:
accessing the satellite image data and obtaining a satellite image from the satellite image data;
inputting the satellite image into a trained model, wherein the trained model outputs a classification indicating whether a dwelling is present in the satellite image;
storing in a dwelling database, when the trained model outputs a classification indicating that a dwelling is present in the satellite image, a dwelling location based on a location associated with the satellite image;
performing a clustering using a plurality of dwelling locations, obtained by retrieving dwelling locations stored in the dwelling database, to determine a clustering of dwellings; and,
outputting the dwelling location for provisioning of a resource to the dwelling, including outputting a cluster location associated with the clustering of dwellings.

20. A computer program product for detecting a dwelling in satellite image data for resource provisioning in rural settlements comprising a computer-readable medium having stored computer-readable program code for performing the steps of:
accessing the satellite image data and obtaining a satellite image from the satellite image data;
inputting the satellite image into a trained model, wherein the trained model outputs a classification indicating whether a dwelling is present in the satellite image;
storing in a dwelling database, when the trained model outputs a classification indicating that a dwelling is present in the satellite image, a dwelling location based on a location associated with the satellite image;
performing a clustering using a plurality of dwelling locations, obtained by retrieving dwelling locations stored in the dwelling database, to determine a clustering of dwellings; and,
outputting the dwelling location for provisioning of a resource to the dwelling, including outputting a cluster location associated with the clustering of dwellings.
